(19) United States
(12) Patent Application Publication
(10) Pub. No.: US 2007/0091506 A1
(43) Pub. Date: Apr. 26, 2007

(54) Magnetic disk drive with air bearing surface design for data area expansion

(75) Inventors: Taichi Nakamura, Kanagawa (JP); Akihiro Sera, Kanagawa (JP); Yasunori Kawamoto, Kanagawa (JP); Takaaki Deguchi, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/584,380

(22) Filed: Oct. 19, 2006

(30) Foreign Application Priority Data
Oct. 20, 2005 (JP) 2005-306462

(51) Int. Cl. G11B 5/60

(52) U.S. Cl. 360/235.8

(57) ABSTRACT

Embodiment of the invention provides a magnetic disk drive that may suppress the decrease of a recording region by preventing a magnetic head slider from abutting a magnetic disk at the time of loading, and suppress the degradation of the flying characteristics. In one embodiment a magnetic disk drive of the present invention is provided with a magnetic head slider including a magnetic transducer, a ramp that unloads the magnetic head slider, and an actuator that moves the magnetic head slider. The magnetic head slider includes a rail surface that generates a positive pressure on an air-bearing surface, a step bearing surface, and a taper section that is formed to a slider corner section that is brought closest to the surface of a recording disk at the time of loading with a space from the rail surface and the step bearing surface.

### CROSS-REFERENCES TO RELATED APPLICATIONS

This application claims priority from Japanese Patent Application No. JP2005-306462, filed Oct. 20, 2005, the entire disclosure of which is incorporated herein by reference.

### BACKGROUND OF THE INVENTION

The present invention relates to a magnetic disk drive and, more specifically, to the configuration of a magnetic disk device provided with a head slider for data recording/reproduction to/from a magnetic disk.

As a data storage device, known is a device of using various types of media, e.g., optical disks, magnetic tapes, and others. Among these, a hard disk drive (HDD) being a magnetic disk drive is widely popular as a storage device for a computer device, and is one of the storage devices that are essential for existing computer systems. Moreover, the application of the HDD goes beyond the computer systems, and is increasing more and more because of its excellent characteristics, e.g., recording and reproduction device of moving images, vehicle navigation system, removable memory used in digital camera, or others.

For the HDD, a magnetic head slider is used that flies over a rotating magnetic disk with a slight space (flying amount) therefrom. Generally, the magnetic head slider is equipped with a magnetic transducer at an air outflow end of the slider for recording/reproducing data to/from a disk-recording medium. For the HDD, it is required to increase, to a further degree, the bit (recording in the circumferential direction) density and the track (recording in the radial direction) density to increase the storage capacity thereof. Especially, as one of the technologies of increasing the bit density, it is required to fly the slider in the low-flying state in the proximity to the magnetic disk as much as possible. For the aim of realizing such difficult low-flying, currently used is a negative pressure slider that has excellent flying stability utilizing the negative pressure in the direction bringing the slider closer to the magnetic disk.

The HDD is further equipped with an actuator that moves the magnetic head slider to any desired position on the magnetic disk. The actuator is driven by a voice coil motor (Voice Coil Motor: VCM), and moves the magnetic head slider on the rotating magnetic disk in the radial direction by moving in a swinging motion about the swing axis. This allows the magnetic transducer to access any desired track formed on the magnetic disk for a data reading/writing process.

The HDD of a load/unload type is equipped with a ramp to which the magnetic head slider takes shelter from the surface of the magnetic disk. The ramp is disposed in the vicinity of the outermost end portion of the magnetic disk. When the rotation of the magnetic disk is stopped, the magnetic head slider is absorbed to the surface of the magnetic disk. Therefore, when the rotation of the magnetic disk is stopped, the actuator moves the magnetic head slider to take shelter from the recording surface of the magnetic disk to the ramp.

The actuator is provided with a suspension and an arm for supporting the magnetic head slider. At the tip end of the suspension, a tab is provided, and when the tab is guided to the ramp, the magnetic head slider is moved from the surface of the magnetic disk to take shelter to the outside for unloading. Conversely, when the tab is moved away from the ramp, the magnetic head slider is moved from the outside of the magnetic disk onto the surface of the magnetic disk for loading.

FIG. 10 shows the state of the magnetic head slider in the HDD of a previous type at the time of loading. A magnetic head slider 905 is supported at a single point by a dimple 960 formed to a suspension 910. At the time of loading, by a tab 916 sliding in contact on the surface of a ramp 902, the suspension 910 moves downward to reach a magnetic disk 901. Thereafter, as the suspension 910 moves downward onto the magnetic disk 901, the magnetic head slider 905 is brought closer to the surface of the magnetic disk 901. There may be a case where the magnetic head slider 905 is skewed toward the latitudinal direction of the slider when it is brought closer at the time of loading, which is caused by variation or twisting of the magnetic head slider 905 when it is attached to the suspension 910. In recent years, because the flying amount of the magnetic head slider 905 is reduced, the magnetic head slider 905 is brought closer to the magnetic disk 901, and thus the end portion of the magnetic head slider 905 sometimes abuts the surface of the magnetic disk 901 (an abutment section 920 of FIG. 10). When the magnetic head slider 905 abuts the magnetic disk 901, the surface of the magnetic disk 901 possibly gets damaged. Therefore, the region including such an abutment section 920 is a load/unload region 921 that is not used for data recording/reproduction. The region toward inside of the load/unload region 921 in the radial direction serves as a data recording region 922 that is used for data recording/reproduction. That is, the region in the vicinity of the abutment section 920 is not suitable for data recording, thereby resulting in a decrease of the recording region.

Patent Documents 1 to 3 are known as describing the magnetic head slider that solves the problem of possibly damaging a recording medium by a magnetic head slider abutting a magnetic disk at the time of loading. In Patent Document 1 (JP-A-2001-351347), a magnetic head slider is trapezoid-shaped. In Patent Document 2 (JP-A-11-306708), a notch is formed to an ABS (Air Bearing Surface) surface. In Patent Document 3 (U.S. Pat. No. 6,552,876), an air outflow end is cut from a corner down to a portion proximal to a center pad (rear pad).

For the purpose of preventing a magnetic head slider from abutting a magnetic disk, as in the aforementioned Patent Documents, if the magnetic head slider is changed in shape in a considerable degree or if the ABS surface or the air outflow end is trimmed to a significant degree, a problem arises that the flying characteristics suffer thereby. Moreover, Patent Document 3 describes that the outer appearance such as the depth of the corner cut portion, the surface roughness, or others, hardly affects the flying characteristics. However, the size reduction of the slider is recently getting active, and if the slider is changed in shape including the ABS surface and the air outflow end, a small-sized slider such as femto slider will be considerably affected especially in terms of the flying characteristics.

### BRIEF SUMMARY OF THE INVENTION

The present invention is proposed in consideration of such problems, and to suppress the decrease of a recording region by preventing a magnetic head slider from abutting a magnetic disk at the time of loading while suppressing the degradation of the flying characteristics.

A magnetic disk drive of the present invention is provided with a magnetic head slider including a magnetic transducer that accesses a recording region of a recording disk; a ramp that unloads the magnetic head slider from the magnetic disk; and an actuator that includes a suspension for supporting the magnetic head slider, and loads/unloads the magnetic head slider to/from the ramp. The magnetic head slider includes: a rear pad having an outflow-side rail surface at a center portion on an air outflow end side of an air bearing surface facing the recording disk; a front pad that extends to a recording disk innermost side and a recording disk outermost side on the air bearing surface, and has a side rail surface on the air outflow end side; and a first taper section that is formed to a first corner of corners vertical to the air bearing surface on the air outflow end side by trimming a predetermined area of an extension region that is an extension portion having the maximum width of the side rail surface extended to the air outflow end. In such a magnetic disk drive, by forming the taper section in a predetermined range, the flying characteristics may be prevented from being degraded, and the magnetic head slider is prevented from abutting the magnetic disk at the time of loading so that it becomes possible to preclude the reduction of the recording region.

In the above magnetic disk drive, the area of trimming the first corner may be the area covering less than 70% of the extension region. Further, in the above magnetic disk drive, the area of trimming the first corner may be the area covering almost 45% of the extension region. Still further, in the above magnetic disk drive, the area of trimming the first corner may be the area covering less than 30% of the extension region. Such configurations enable to effectively prevent the flying characteristics of the magnetic head slider from being degraded.

In the above magnetic disk drive, the first taper section may be formed with a space from the side rail surface, and not covering a region on the side of the outflow-side rail surface closer than the side rail surface. Such configuration enables to effectively prevent the flying characteristics of the magnetic head slider from being degraded.

In the above magnetic disk drive, the first taper section may be formed to a corner on the recording disk innermost side among other corners on the air outflow end side of the magnetic head slider. Such a configuration prevents the magnetic head slider from abutting the magnetic disk at the time of loading.

In the above magnetic disk drive, the first taper section may be formed with a space from the side rail surface on the magnetic disk innermost side. Such a configuration prevents the magnetic head slider from abutting the magnetic disk at the time of loading.

In the above magnetic disk drive, the front pad may be further provided with a side step bearing surface that is formed with a height difference from the side rail surface, and the first taper section may be formed with a space from the side step bearing surface. Such a configuration suppresses the decrease of a negative pressure.

In the above magnetic disk drive, the first taper section may be formed not to cover the side rail surface when viewed from the side of the air-bearing surface. Such a configuration suppresses the degradation of the flying characteristics of the magnetic head slider.

In the above magnetic disk drive, the first taper section may be formed outside of a line that is drawn to abut the side rail surface corresponding to a skew angle. Such a configuration suppresses the degradation of the flying characteristics of the magnetic head slider.

In the above magnetic disk drive, the magnetic head slider may have a negative pressure generation surface that generates a negative pressure on the air-bearing surface, and the first taper section may be formed from the negative pressure generation surface toward a surface opposite to the air-bearing surface. Such a configuration suppresses the degradation of the flying characteristics of the magnetic head slider.

In the above magnetic disk drive, the magnetic head slider may be further provided with a second taper section at a second corner on the recording disk outermost side among the corners on the air outflow end side of the magnetic head slider. Such a configuration enables to keep the balances of the magnetic head slider and suppresses the degradation of the flying characteristics of the magnetic head slider.

In the above magnetic disk drive, the second taper section may be formed with a space from the side rail surface on the magnetic disk outermost side. Such a configuration suppresses the degradation of the flying characteristics of the magnetic head slider.

A magnetic disk drive of the present invention includes: a magnetic head slider including a magnetic transducer that accesses a recording region of a recording disk; a ramp that unloads the magnetic head slider from the magnetic disk; and an actuator that includes a suspension for supporting the magnetic head slider, and loads/unloads the magnetic head slider to/from the ramp. Included are: a front pad provided on the air inflow end side of an air-bearing surface facing the recording disk; an innermost-side side step bearing surface that extends the front pad on the recording disk innermost side; an innermost-side side rail surface that is provided on the innermost-side side step bearing surface, and is protruding to the side of the recording disk; and a taper section formed by vertically removing the air-bearing surface only on the side of the air outflow direction from a position at almost 50% of a line extending in the air outflow direction at the time of loading from an air outflow end of the innermost-side side rail surface. In such a magnetic disk drive, by forming the taper section in a predetermined range, the flying characteristics may be prevented from being degraded, and the magnetic head slider is prevented from abutting the magnetic disk at the time of loading so that it becomes possible to preclude the reduction of the recording region.

A magnetic disk drive according to the present invention includes: a magnetic head slider including a magnetic transducer that accesses a recording region of a recording disk, an ABS surface provided to an air-bearing surface facing the recording disk, and a chamfering section that chamfers a region covering from a corner on the side of an air outflow end vertical to the air-bearing surface to a region not covering the ABS surface; a ramp that unloads the magnetic head slider from the magnetic disk; and an actuator that includes a suspension for supporting the magnetic head slider, and moves the magnetic head slider. In such a magnetic disk drive, by forming the chamfering section with a space from the ABS surface, the flying characteristics may be prevented from being degraded, and the magnetic head slider is prevented from abutting the magnetic disk at the time of loading so that it becomes possible to preclude the reduction of the recording region.

According to the present invention, there provides a magnetic disk drive with which a recording region may be expanded further to the outermost side by preventing, without reducing the flying characteristics, a magnetic head slider from abutting a magnetic disk at the time of loading.

### BRIEF DESCRIPTION OF THE DRAWINGS

FIG. 1 is a plan view showing the schematic configuration of a hard disk drive of the present embodiment.

FIG. 2 is a perspective view showing the configuration of a magnetic head slider of the present embodiment.

FIG. 3 is a plan view showing the configuration of the magnetic head slider of the present embodiment.

FIG. 4 is a plan view showing the configuration of the magnetic head slider of the present embodiment.

FIG. 5 is a graph diagram showing the flying characteristics of the magnetic head slider of the present embodiment.

FIG. 6 is an exemplary schematic diagram for illustrating the range for a taper section of the magnetic head slider of the present embodiment.

FIG. 7 is a schematic diagram showing the state when the magnetic head slider of the present embodiment flies.

FIG. 8 is a schematic diagram showing the state, at the time of loading, of the magnetic head slider of the present embodiment.

FIG. 9 is a schematic diagram showing the state, at the time of loading, of the magnetic head slider of the present embodiment.

FIG. 10 is a schematic diagram showing the state, at the time of loading, of a conventional magnetic head slider.

### DETAILED DESCRIPTION OF THE INVENTION

The following description is given to illustrate the embodiment of the present invention, and the present invention is not restrictive to the following embodiment. For those skilled in the art, the components of the following embodiment may be easily modified, added, and changed without departing from the scope of the invention. Note that, in the drawings, any identical components share the same reference numeral, and any same description is not made again if appropriate.

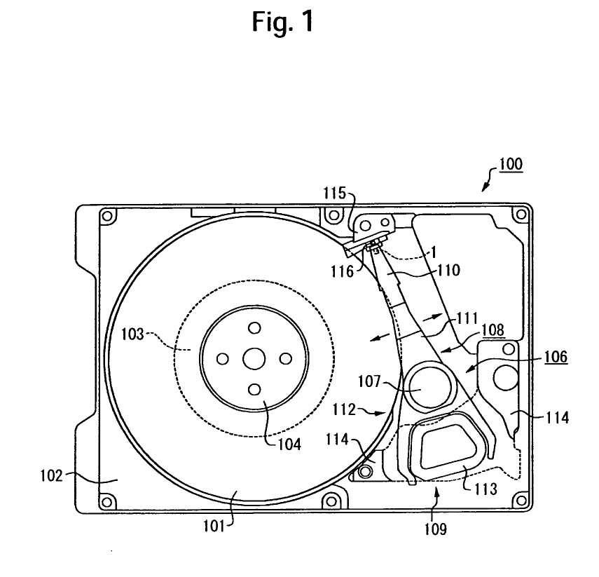

FIG. 1 is a drawing showing the schematic configuration of a hard disk drive (HDD) 100 according to this embodiment. FIG. 1 shows the state of the HDD 100 when an actuator is disposed at the position when it is stopped (not in operation). A magnetic disk 101 is a medium for recording of data, and is a nonvolatile recording disk that becomes available for recording of data through magnetization of a magnetic layer. A base 102 is fixed to a cover (not shown) that blocks the upper aperture of the base 102 via a gasket (not shown) so that a disk enclosure is configured. The constituent components of the HDD 100 may be thus housed in a sealed state.

Reference numeral 103 denotes a spindle motor, and reference numeral 104 denotes a clamp for fixing the magnetic disk 101 to the spindle motor 103. The magnetic disk 101 is rotationally driven by the spindle motor 103 fixed to the bottom surface of the base 102 at a predetermined angular speed. When the HDD 100 is not in operation, the magnetic disk 101 is stationary.

Reference numeral 1 denotes a magnetic head slider equipped with a magnetic transducer (not shown) that performs reading/writing, from/to the magnetic disk 101, data coming/going from/to a host (not shown). The magnetic transducer is formed, as a unit, with a recording element that converts an electric signal to a magnetic field in accordance with the data recorded to the magnetic disk 101, and a reproduction element that coverts a magnetic field from the magnetic disk 101 to an electric signal. Alternatively, the recording element and the reproduction element may be separately formed. Still alternatively, the present invention may be applied to an HDD including either the recording element or the reproduction element.

Reference numeral 106 denotes an actuator that retains and moves the magnetic head slider 1. The actuator 106 is retained by a swing axis 107 to be freely put in a swinging motion, and is provided with a carriage 108 and a VCM (Voice Coil Motor) 109 serving as a drive mechanism. The carriage 108 is provided with the components, which are coupled together in order of, from the tip end portion disposed with the magnetic head slider 1, a suspension 110, an arm 111, and a coil support 112. The suspension 110 is supporting, at a single point, the magnetic head slider 1 by a dimple (not shown) provided on the side facing the magnetic disk 101.

The coil support 112 retains a flat coil 113. Reference numeral 114 denotes an upper stator magnet retention plate fixed to the base 102, and sandwiches the flat coil 113 with a lower stator magnet retention plate (not shown).

Reference numeral 115 denotes a ramp to which the magnetic head slider 1 takes shelter from the surface of the magnetic disk 101 when the rotation of the magnetic disk 101 is stopped. Reference numeral 116 denotes a tab formed at the tip end portion of the suspension 110. The ramp 115 is in the proximity of the outermost end portion of the magnetic disk 101. The ramp 115 is attached to the bottom surface or the side surface of the base 102 by a column located at the position outside of the path of the tab 116.

The VCM 109 puts the carriage 108 in a swinging motion about the swing axis 107 in accordance with a drive signal provided by a controller (not shown) to the flat coil 113, and moves the magnetic head slider 1 onto the recording surface of the magnetic disk 101. In an alternative manner, it may move the magnetic head slider 1 to the ramp 115 from the recording surface of the magnetic disk 101.

For data reading/writing from/to the magnetic disk 101, the actuator 106 moves the magnetic head slider 1 to an upper portion of the data region on the surface of the rotating magnetic disk 101. By the swinging motion of the actuator 106, the magnetic head slider 1 moves along the radial direction of the recording surface of the magnetic disk 101. This enables the magnetic head slider 1 to access any desired track. The magnetic head slider 1, with a balance between the pressure of air viscosity between the air-bearing surface of the slider facing the magnetic disk 101 and the rotating magnetic disk 101 and the pressure applied by the suspension 110 in the direction of the magnetic disk 101, the magnetic head slider 1 flies over the magnetic disk 101 with a fixed gap therefrom.

When the rotation of the magnetic disk 101 is stopped, the magnetic head slider 1 abuts the surface of the magnetic disk 101, and an absorption phenomenon gives rise to problems of causing flaws in the data region, disabling the rotation of the magnetic disk 101, and the like. In consideration thereof, when the rotation of the magnetic disk 101 is stopped, the actuator 106 moves the magnetic head slider 1 to take shelter from the data region to the ramp 115. When the actuator 106 rotates and moves in the direction of the ramp 115, and when the tab 116 at the tip end of the actuator 106 reaches the parking surface (stop surface) on the ramp 115 by moving to slide in contact on the surface of the ramp 115, the magnetic head slider 1 is unloaded. At the time of loading, the actuator 106 being supported by the parking surface moves away from the ramp 115, and moves onto the surface of the magnetic disk 101.

Herein, the magnetic disk 101 may be configured by one or more pieces, and may be available for one-sided recording or double-sided disk recording. If it is available for double-sided recording, the suspension for retaining the head for scanning of the recording surfaces is provided as many in number as the recording surfaces, and with respect to a piece of the magnetic disk 101, is fixed to the coil support 112 via an arm at a position overlapping the other suspension 110 with a predetermined space therefrom. For double-sided recording of a plurality of magnetic disks, the clamp 104 is used to retain, as a piece, a plurality of magnetic disks in the direction of a rotation axis of the spindle motor 103 with a predetermined spacing. The suspension retaining the head for scanning the respective recording surfaces is provided as many in number as the recording surfaces, and is fixed at the position overlapping the suspension 110 of FIG. 1 with a predetermined space therefrom. With this being the case, the member including the suspension 110 and the arm 111 as a piece may be stacked for fixation with the coil support 112 using the swing axis 107, or a member including the arm 111 as many in number as the head is cast for fixation of the suspension 110 and the coil support 112 thereto.

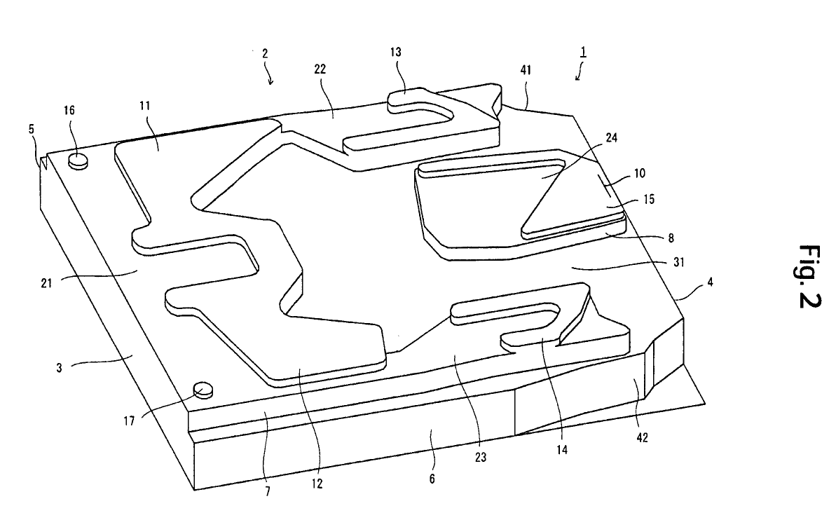

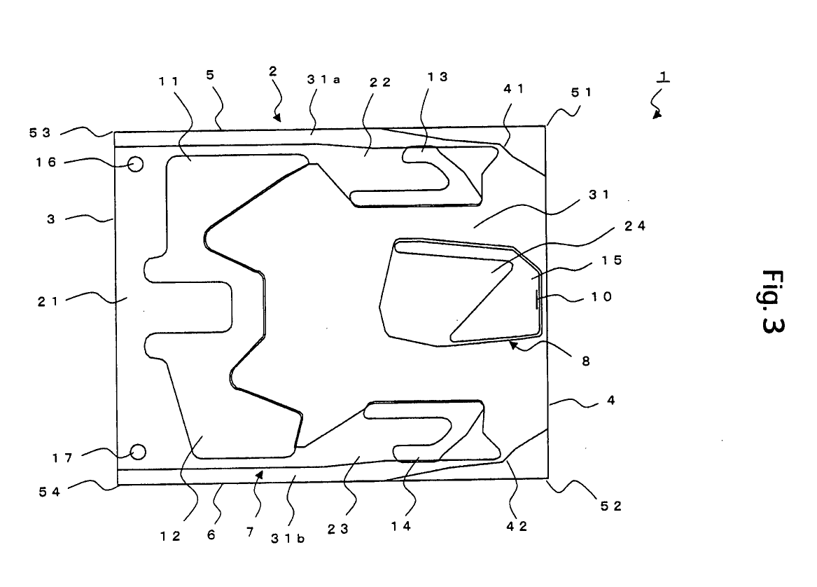

Described in detail next is the magnetic head slider of this embodiment. FIGS. 2 and 3 are, respectively, a perspective view and a plan view of the magnetic head slider of this embodiment. This magnetic head slider 1 is a femto slider having the size of 0.850 mm×0.700 mm. The magnetic head slider 1 is formed with a front pad 7 and a rear pad 8 on the surface of the slider body, and includes an air-bearing surface 2 that is a surface facing the magnetic disk 101, an air inflow end 3 on the side of the magnetic disk 101 into which the air flow flows, an air outflow end 4 on the side from which the air flow flows, a disk outermost end 5 on the outermost side of the magnetic disk, and a disk innermost end 6 on the innermost side of the magnetic disk. The air-bearing surface 2 is configured by a front step bearing surface 21, inflow-side rail surfaces 11 and 12, an outermost-side side step bearing surface 22, an innermost-side side step bearing surface 23 (hereinafter, side step bearing surfaces 22 and 23), an outermost-side side rail surface (hereinafter, outermost-side rail surface) 13, an innermost-side side rail surface (hereinafter, innermost-side rail surface) 14, a rear step bearing surface 24, an outflow-side rail surface 15, and a deep groove surface 31.

The front pad 7 is provided on the side of the air inflow end 3 on the surface of the slider body, and includes the front step bearing surface 21, and the inflow-side rail surfaces (positive pressure generation surfaces) 11 and 12 formed on the front step bearing surface 21 to have a height difference therefrom. The front step bearing surface 21 is formed continuously from the air inflow end 3. The inflow-side rail surface 11 is formed on the side of the disk outermost end 5, and the inflow-side rail surface 12 is formed on the side of the disk innermost end 6. In this example, the inflow-side rail surfaces 11 and 12 are formed continuously as a piece, but may be separately formed.

Moreover, the front pad 7 includes, on the side of the disk outermost end 5 and on the side of the disk innermost end 6 on the surface of the slider body, the side step bearing surfaces 22 and 23, and the outermost-side rail surface 13 and the innermost-side rail surface 14 formed on the side step bearing surfaces 22 and 23 to have a height difference therefrom. The side step bearing surfaces 22 and 23 are formed continuously from the front step bearing surface 21, and have the same depth as the front step bearing surface 21.

The deep groove surface (negative pressure generation surface) 31 is provided at the center portion on the surface of the slider body, and the side of the air inflow end 3, the disk innermost side, and the disk outermost side are enclosed by the front pad 7. The deep groove surface 31 is formed to be deeper than the front pad 7 and the rear pad 8. Further, on the more outermost side disk and more innermost side of the disk than the front pad 7, deep grooves 31a and 31b are formed with the same depth as the deep groove surface 31.

The rear pad 8 is formed on the side of the air outflow end 4 on the surface of the slider body with the deep groove surface 31 disposed between the front pad 7, and includes the rear step bearing surface 24, and the outflow-side rail surface 15 formed on the rear step bearing surface 24 to have a height difference therefrom. The rear step-bearing surface 24 has the same depth as the front step-bearing surface 21. On the side of the air outflow end 4 of the outflow-side rail surface 15, the magnetic transducer 10 is provided for data recording/reproduction to/from the magnetic disk 101. Note here that the rear pad 8 is formed at the center portion of the air outflow end 4, but may be formed to the region off from the center portion.

The rail surfaces 11 to 15 have almost the same height, and by the air flow flowing in between the air-bearing surface 2 of the magnetic head slider 1 and the magnetic disk 101, the positive pressure is generated in the direction that the magnetic head slider 1 moves away from the surface of the magnetic disk so that the magnetic head slider 1 is flown over the disk medium. The step bearing surfaces 21 to 24 have almost the same height, and each have a predetermined depth from the rail surfaces 11 to 15. The air flow flowing in from the air inflow end 3 reaches the inflow-side rail surfaces 11 and 12, the outermost-side rail surface 13, the innermost-side rail surface 14, and the outflow-side rail surface 15 after going through the front step bearing surface 21, the side step bearing surfaces 22 and 23, and the rear step bearing surface 24, and in the meantime, the positive pressure is generated. The depth of the deep groove surface 31 is deeper than those of the rail surfaces 11 to 15 and the step bearing surfaces 21 to 24, and by the incoming air flow, the negative pressure is generated in the direction such that the magnetic head slider 1 is brought closer to the surface of the magnetic disk. Note here that the rail surface and the step-bearing surface are collectively referred to as the ABS surface.

In the vicinity of the highest points of slider corner sections 53 and 54 on both ends on the side of the air inflow end 3, the magnetic head slider 1 has inflow pads 16 and 17 having the same height as the rail surfaces 11 to 15. If the air inflow end 3 is skewed toward the side of the magnetic disk more than the air outflow end 4 in the longitudinal direction of the slider (pitch direction)(when the pitch angle is negative), and with any external shock, the air inflow end 3 may come closer to and abut the magnetic disk 101. If this is the case, the inflow pads 16 and 17 abut the magnetic disk 101 before the air inflow end 3 does so that the abutment area is reduced between the magnetic head slider 1 and the magnetic disk 101, thereby enabling to reduce the friction. In consideration thereof, the height of the inflow pads 16 and 17 is preferably made higher than the height of the air inflow end 3 (the height of the front step bearing surface 21) to make those abut the magnetic disk 101 before the air inflow end 3 does. In this example, to enable manufacturing in the same manufacture process as the rail surfaces 11 to 15, the inflow pads 16 and 17 are made to have the same heights as the rail surfaces 11 to 15. Moreover, by providing the inflow pads 16 and 17 in the vicinity of the slider corner sections 53 and 54 on the side of the air inflow end 3, the influences over the air flow flowing to the inflow-side rail surfaces 11 and 12 may be reduced.

Note here that the inflow pads 16 and 17 may be formed on the side of the air outflow end 4 of the front pad 7 or on the rear pad 8.

The magnetic head slider 1 of this embodiment has an outermost-side taper section 41 and an innermost-side taper section 42 to the slider corner sections 51 and 52, respectively, on both ends of the air outflow end 4. The outermost-side taper section 41 and the innermost-side taper section 42 are formed by trimming the slider corner sections 51 and 52 by etching or the like. The outermost-side taper section 41 and the innermost-side taper section 42 are formed in the diagonal direction from the air outflow ends 4 to the disk outermost end 5 and the disk innermost end 6, respectively. The outermost-side taper section 41 and the innermost-side taper section 42 are formed deeper than the deep groove surface 31, and formed from the air-bearing surface 2 to be substantially vertical to the air-bearing surface 2 toward the surface opposite to the air-bearing surface 2.

The outermost-side taper section 41 and the innermost-side taper section 42 are formed with a space from the outermost-side rail surface 13 and the innermost-side rail surface 14, respectively, and are formed from the deep groove surface 31 toward the surface opposite to the air-bearing surface 2 with a space from the side step bearing surfaces 22 and 23, respectively. With a positive pitch angle, the outermost-side rail surface 13 and the innermost-side rail surface 14 come closest to the magnetic disk 101 so that the sizes and shapes of the outermost-side rail surface 13 and the innermost-side rail surface 14 greatly affect the flying characteristics. By forming the outermost-side taper section 41 and the innermost-side taper section 42 with a space from the outermost-side rail surface 13 and the innermost-side rail surface 14, respectively, the surfaces remain the same shape so that it is possible not to affect the flying characteristics that much. Moreover, the side step bearing surfaces 22 and 23 are formed to protrude also to the side of the air outflow end 4 more than the outermost-side rail surface 13 and the innermost-side rail surface 14. As if to avoid these side step bearing surfaces 22 and 23, the outermost-side taper section 41 and the innermost-side taper section 42 are formed bent in the vicinity of the tip end portion on the side of the air outflow end 4 of the side step bearing surfaces 22 and 23 when viewed from above the air-bearing surface 2. With such a configuration that the side step bearing surfaces 22 and 23 are protruded to the side of the air outflow end 4 more than the outermost-side rail surface 13 and the innermost-side rail surface 14 when viewed from above the air-bearing surface 2, when the magnetic disk is flying, the air flow prevents the dust from entering from the outermost end 5 and the innermost end 6 to the rear pad 8. Moreover, if the side of the air outflow end 4 of the side step bearing surfaces 22 and 23 is trimmed, this affects not only the positive pressure to be generated on the outermost-side rail surface 13 and the innermost-side rail surface 14 but also the negative pressure to be generated on the side of the outflow end thereof. In consideration thereof, as in the present embodiment, when the outermost-side rail surface 13 and the innermost-side rail surface 14 share the same width as the side step bearing surfaces 22 and 23, it is preferable to form the outermost-side taper section 41 and the innermost-side taper section 42 in such a manner as not to change the shape of the side step bearing surfaces 22 and 23.

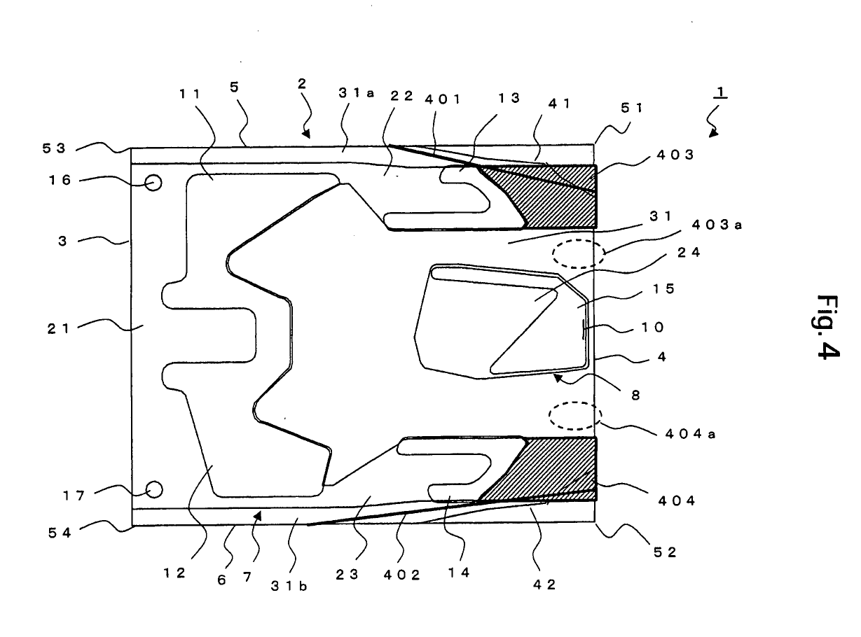

By referring to FIG. 4, described now are preferred requirements for the outermost-side taper section 41 and the innermost-side taper section 42. In FIG. 4, 401 denotes a skew line (line corresponding to a skew angle) on the outermost side of the disk, and 402 denotes another skew line on the innermost side of the disk. The direction along which the skew lines 401 and 402 extend toward the air outflow end 4 is the direction of the airflow. Therefore, the side closer to the center of the magnetic head slider 1 than the skew lines 401 and 402 becomes a portion greatly affected by the airflow. Accordingly, to reduce the influence over the flying characteristics of the magnetic head slider 1, it is preferable if the outermost-side taper section 41 is located closer to the side of the outermost end 5 of the disk than the skew line 401, and the innermost-side taper section 42 is located closer to the side of the innermost end 6 of the disk than the skew line 402. When the outermost-side taper section 41 is located on the side of the outermost end 5 of the disk closer than the skew line 401, and when the innermost-side taper section 42 is located on the side of the innermost end 6 of the disk closer than the skew line 402, when a skew angle is formed, the pressure hardly fluctuates on the side of the air outflow end 4 as a result of provision of the taper sections. Therefore, the flying characteristics are not degraded.

In FIG. 4, reference numeral 403 denotes an extension region derived by extending the maximum width of the outermost-side rail surface 13 to the air outflow end 4, i.e., a region enclosed by two extension lines that vertically extend to the air outflow end 4 from the positions of the maximum width of the outermost-side rail surface 13. Similarly, reference numeral 404 denotes an extension region derived by extending the maximum width of the innermost-side rail surface 14 to the side of the air outflow end 4. These regions affect the flying characteristics by being trimmed similarly to the side closer to the center than the skew lines 401 and 402. In consideration thereof, the area of the outermost-side taper section 41 and the innermost-side taper section 42, i.e., the area of the regions to be trimmed from the slider corner sections 51 and 52, is preferably lower in ratio than the following ratio for the area of the extension regions 403 and 404. Note that, in this example, described is the area of the outermost-side taper section 41 and the innermost-side taper section 42. This area is the area when the slider corner sections 51 and 52 are trimmed in the range being away from the rail surfaces 13 and 14 as described above. That is, in the range being away from the rail surfaces 13 and 14, by having the following area, the outermost-side taper section 41 and the innermost-side taper section 42 are defined by shape. When the slider corner sections 51 and 52 are trimmed, the slider corner sections 51 and 52 are chamfered, and the slider corner sections are trimmed from the outermost-side of the rail surfaces 13 and 14, the outermost-side taper section 41 and the innermost-side taper section 42 do not cause the magnetic disk to abut at the time of loading.

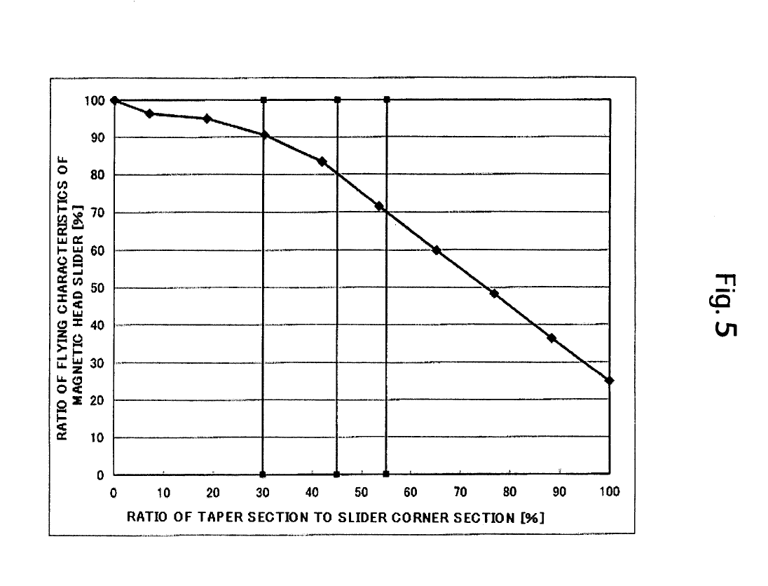

FIG. 5 shows the relationship between the ratio of trimming the slider corner sections (the extension regions 403 and 404 of FIG. 4) and the flying characteristics of the magnetic head slider. In FIG. 5, the horizontal axis indicates the ratio of trimming the slider corner sections (the ratio of the taper sections to the area of the extension regions 403 and 404), and 0% denotes the case that the slider corner sections are not trimmed at all. The vertical axis indicates the ratio that the flying characteristics of the magnetic head slider 1 are degraded, and 100% denotes the flying characteristics of the case that the slider corner sections are not trimmed at all. The flying characteristics denote the change of a pressure generated on the air-bearing surface 2 when the slider corner sections are trimmed. The flying characteristics herein mean the stability of the flying amount, derived by calculation with an assumption of parameter fluctuations for controlling the mass-produced magnetic head sliders 1 not to vary in flying amount. Herein, if the slider corner sections 51 and 52 are trimmed toward the rail surfaces 13 and 14, as long as the requirements for the area are satisfied for the outermost-side taper section 41 and the innermost-side taper section 42 on the downstream of the air flow, the shapes of the outermost-side taper section 41 and the innermost-side taper section 42 hardly affect the flying characteristics compared with the fluctuations of the area.

As shown in the drawing, as the ratio of trimming the slider corner sections is increased, the flying characteristics are degraded. Especially with the magnetic head slider 1 of this embodiment, as is being a femto slider, the flying characteristics thereof are more dependent on the trimming ratio and are degraded to a further degree. For example, if the slider corner sections 51 and 52 are trimmed 100% (the same area for the extension regions 403 and 404), the flying characteristics are reduced down to about 25%. Herein, if the slider corner sections 51 and 52 are trimmed 100%, the slider corner sections 51 and 52 abut the rail surfaces 13 and 14, respectively, but the rail surface 13 and 14 are not deformed in shape.

In terms of the flying characteristics, it is preferable if the slider corner sections 51 and 52 are not trimmed that much. On the other hand, to prevent the abutment at the time of loading to a further extent, it is preferable that the larger portions of the slider corner sections 51 and 52 are trimmed. However, this resultantly degrades the flying characteristics, and increases the difficulty to make adjustments at the time of incorporation to the HDD. In consideration thereof, in a case where the flying characteristics are assigned higher priorities, the slider corner sections 51 and 52 may be trimmed about 30% to suppress the degradation of the flying characteristics to about 10%. If with the degradation of about 10%, the ratio will be almost the same as a variation difference among the sliders or a tolerance at the time of incorporation to the HDD. Therefore, there is no need to give much consideration to the degradation of the flying characteristics for use. On the other hand, in a case where the abutment control is assigned higher priorities, the slider corner sections 51 and 52 may be trimmed to the verge of making steeper the slope of the degradation of the flying characteristics, i.e., trimmed about 45% being a range that may suppress the degradation of the flying characteristics of about 20%. With the degradation of about 20%, the incorporation to the HDD is possible by going though adjustment in some level.

Here, FIG. 5 shows the flying characteristics assuming that the tolerance when the magnetic head slider 1 retained by the suspension 101 is incorporated to the HDD 100 together with the actuator 106 takes a value when the magnetic head slider 1 is skewed by 1 degree in the roll direction. When this tolerance is smaller in value, the flying characteristics are improved because the magnetic head slider 1 is not skewed that much. For example, if the tolerance is reduced to a half in value, the degradation degree of the flying characteristics is also reduced to a half. As an example, when the magnetic head slider 1 is skewed by 1 degree, if the slider corner sections 51 and 52 are trimmed down to 70%, the flying characteristics will be 60% in ratio, and the degradation level will be 40%. If the slider is skewed 0.5 degree, the degradation level will be 20% so that it becomes available for use.

Note here that, in the previous example of the aforementioned Patent Document 3, the air outflow end is trimmed to the region in the vicinity of the rear pad. This decreases the airflow flowing onto the rear pad, and the positive pressure generated on the rail surface on the rear pad. What is more, the negative pressure generated in the negative pressure groove is also decreased, and thus it causes a problem of greatly affecting the bearing capability for retaining the flying height of the slider, and the flying characteristics. When the positive pressure is decreased, at the time of loading, it takes time until the magnetic head slider is stabilized in posture, and in the mean time, the slider may abut the magnetic disk. Even when it is flying over the magnetic disk, the possibility is increased of abutting the magnetic disk if there is any external shock. In consideration thereof, in this embodiment, preferably, the outermost-side taper section 41 and the innermost-side taper section 42 are not provided to regions 403a and 404a that are located closer to the side of the rear pad 8 than the extension regions 403 and 404 (the center side of the magnetic head slider in the latitudinal direction), and the air outflow end 4 is not trimmed to the side closer to the center portion than the extension regions 403 and 404. With such a configuration that the air outflow end 4 is not trimmed to the region in the vicinity of the rear pad 8, it becomes possible to prevent the degradation of the bearing capability and the degradation of the flying characteristics.

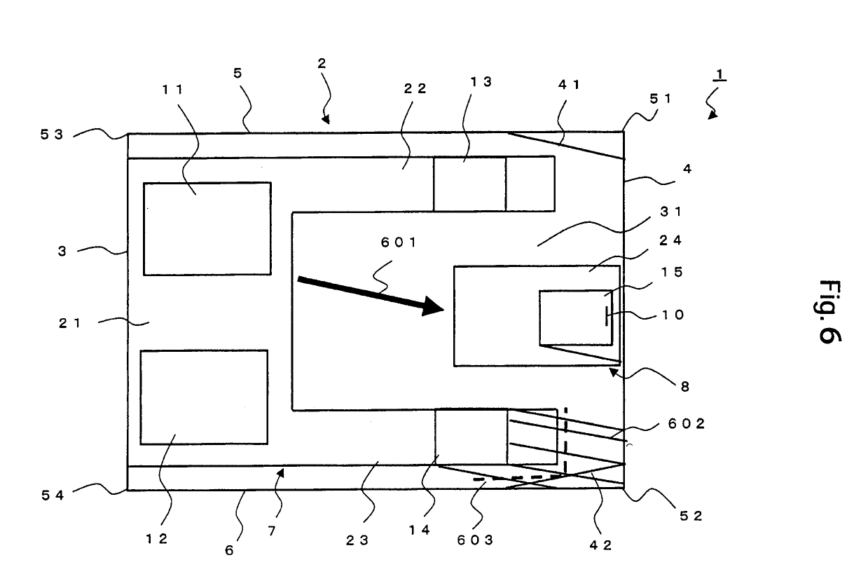

Moreover, in this embodiment, to avoid abutment between the magnetic head slider 1 and the magnetic disk 101 at the time of loading, it is preferable if the innermost-side taper section 42 is at least provided to the slider corner section 52 on the innermost side of the magnetic disk on the air outflow end 4. With only the innermost-side taper section 42 without the outermost-side taper section 41, the abutment between the magnetic head slider 1 and the magnetic disk 101 may be prevented at the time of loading. With the innermost-side taper section 42 together with the outermost-side taper section 41, it becomes possible to prevent the degradation of the flying characteristics while the magnetic head slider 1 is balanced. Here, described now is a further preferred requirement for the innermost-side taper section 42 by referring to FIG. 6.

In FIG. 6, reference numeral 601 denotes the air flow flowing over the air-bearing surface 2 of the magnetic head slider 1 at the time of loading. That is, at the time of loading, the air flow 601 flows from the side of the outermost end 5 of the disk on the air inflow end 3 toward the side of the innermost end 6 of the disk on the air outflow end 4, and flows out in the diagonal direction with respect to the outermost end 5 of the disk and the innermost end 6 of the disk. In FIG. 6, reference numeral 602 denotes a line drawn in the direction along which the air flow 601 flows from the air outflow end of the innermost-side rail surface 14 to the downstream side, i.e., a line drawn from the side of the air outflow end 4 of the innermost-side rail surface 14 and the side of the innermost end 6 of the disk, and is a downstream line indicating the downstream (downwind) portion of the innermost-side rail surface 14 at the time of loading. In this example, the line connecting the portions of a predetermined ratio with respect to the downstream line 602 is referred to as a boundary line 603.

In this embodiment, the innermost-side taper section 42 is formed on the side closer to the slider corner section 52 than this boundary line 603. For example, the ratio of the boundary line 603 to the downstream line 602 is 50%. That is, the innermost-side taper section 42 is preferably formed outside of the 50% of the downstream line drawn from the innermost-side rail surface 14. Note that, in the drawing, the rail surface is simplified and is shown as a square. Such a shape is not the only option, and the shape as shown in FIG. 3 enables to draw a boundary line similarly. As described in the foregoing, if the taper sections are provided on the outflow end side of the rail surfaces 13 and 14 or the side step bearing surfaces 22 and 23 (downstream side of the air flow), the pressure to be generated will fluctuate. However, the experimental result indicates that the fluctuations will be reduced if some space is provided from the farthest side of the outflow end side of the rail surfaces 13 and 14 or the side step bearing surfaces 22 and 23. More in detail, if they are provided outside (downstream side) of 50% of the line drawn to the downstream from the innermost-side rail surface 14, the degradation of the flying characteristics will be suppressed to 20%, which is about the same as the case of trimming the slider corner sections 51 and 52 of FIG. 5 about 45%. Here, the outermost-side taper section 41 may be trimmed with the similar ratio.

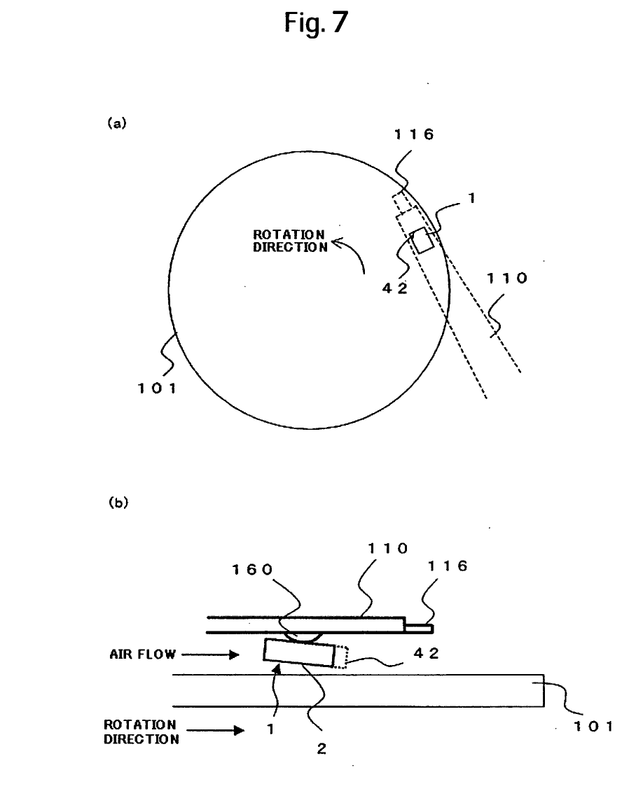

Described next is the operation of the magnetic head slider of this embodiment. FIG. 7 is showing the state in which the magnetic head slider 1 is positioned on the magnetic disk 101. FIG. 7(a) is a view of the magnetic disk 101 viewed from the above, and FIG. 7(b) is a view of the magnetic disk 101 viewed from the side.

As shown in FIGS. 7(a) and (b), on the magnetic disk 101, the airflow is generated toward the rotation direction of the magnetic disk 101. The airflow flows along the magnetic head slider 1, and generates the buoyant force of the magnetic head slider 1 by acting on the rail surfaces 11 to 15 of the air-bearing surface 2. When the airflow passes over the deep groove surface 31 of the air-bearing surface 2, the negative pressure is generated on the deep groove surface 31 by the airflow. The magnetic head slider 1 is supported by, at a single point, a dimple 160 attached to the suspension 110, and the balance between the buoyant force generated by the rail surfaces 11 to 15 and the negative pressure generated on the deep groove surface 31 determines the flying amount or posture of the magnetic head slider 1. With the above configuration that the deep groove surface 31 is formed from the center portion of the air-bearing surface 2 toward the side of the air outflow end 4, the flying amount is increased on the upstream side of the air flow more than the downstream side thereof, and the magnetic head slider 1 flies in the posture with the positive pitch angle. That is, on the magnetic disk 101, the magnetic head slider 1 is skewed in the longitudinal direction of the slider, and is flying in such a manner that the air outflow end 4 is lower than the air inflow end 3. With such a configuration, the magnetic transducer 10 disposed on the side of the air outflow end 4 may be brought much closer to the surface of the magnetic disk.

When the magnetic head slider 1 flies in such a posture, and at the time of loading, the innermost side of the disk is skewed toward the side of the magnetic disk more than the outermost side of the disk (negative roll angle) in the roll direction. Therefore, the air outflow end 4 of the magnetic head slider 1 abuts the magnetic disk 101 with more ease than the air inflow end 3 does. In this embodiment, by providing the innermost-side taper section 42 to the slider corner section 52 on the side of the air outflow end 4, the magnetic head slider may be prevented from abutting the magnetic disk at the time of loading.

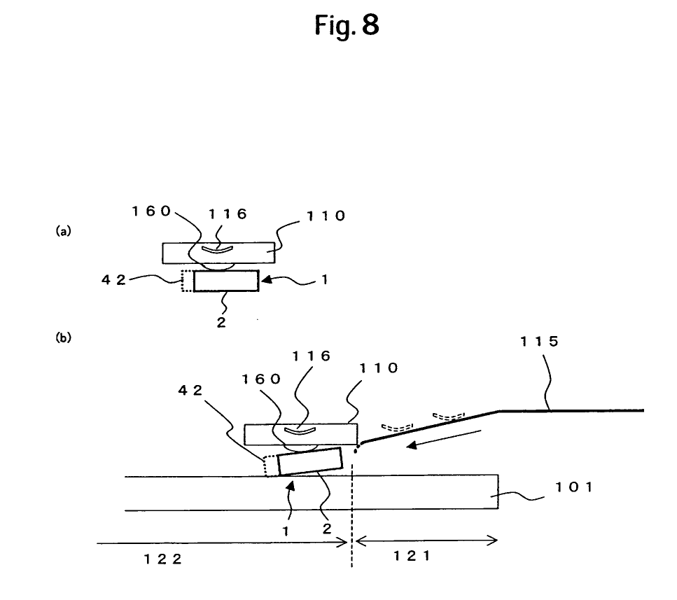

FIG. 8(a) shows the state of the magnetic head slider 1 as viewed from the tip end side of the suspension when it is moved away from the magnetic disk. When not flying on the magnetic disk, i.e., when the airflow is not acting on the magnetic head slider 1, the magnetic head slider 1 is supported to be parallel to the suspension 110, and is balanced in the horizontal direction against the latitudinal direction of the slider.

FIG. 8(b) is showing the state of the magnetic head slider viewed from the tip end side of the suspension at the time of loading. At the time of loading, when the tab 116 moves to slide in contact on the surface of the ramp 115, the suspension 110 moves downward to reach the magnetic disk 101. As the suspension 110 moves downward to reach the magnetic disk 101, the magnetic head slider 1 is brought closer to the surface of the magnetic disk 101. The magnetic head slider 1 is skewed toward the latitudinal direction of the slider when it is brought closer at the time of loading. This is due to variation or twisting when the magnetic head slider 1 is attached to the suspension 110.

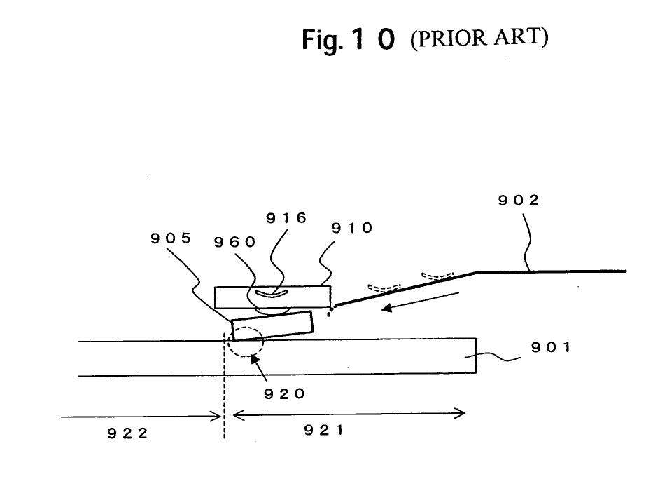

In the previous example of FIG. 10, the end portion of the magnetic head slider abuts the surface of the magnetic disk at this time. In this embodiment, on the other hand, as shown in FIG. 8(b), the magnetic head slider 1 does not abut the magnetic disk 101 due to the presence of the innermost-side taper section 42 provided to the slider corner section 52 of the magnetic head slider 1. Accordingly, because there is no need to reduce the size of the recording region in consideration of such possible abutment of the magnetic head slider, compared with the previous example, the load/unload region 121 may be reduced in size, and the data recording region 122 may be expanded to the outermost side of the magnetic disk.

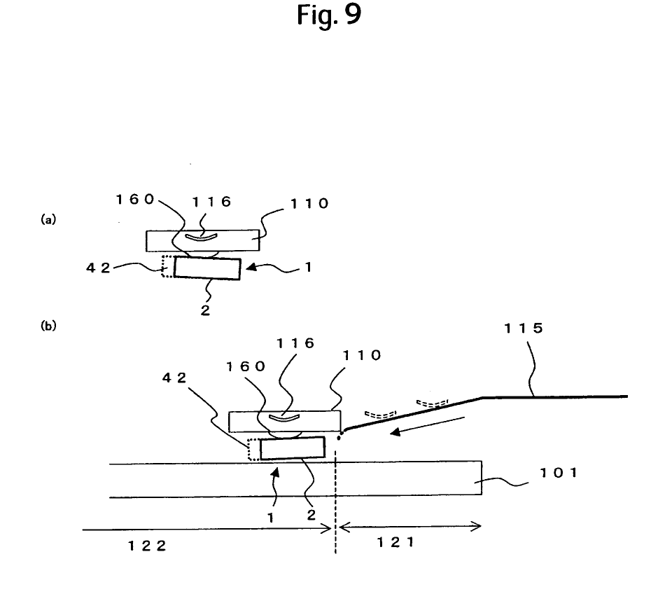

Note here that, in the example of FIG. 8, the magnetic head slider is disposed horizontal. Alternatively, the magnetic head slider may be tilted in advance. FIG. 9(a) shows the state of the magnetic head slider viewed from the tip end side of the suspension when it is away from the magnetic disk. In this example, the magnetic head slider 1 is supported askew against the suspension 110 in the latitudinal direction of the slider so that the outermost side of the magnetic disk is placed below the innermost side of the magnetic disk.

FIG. 9(b) shows the state of the magnetic head slider viewed from the tip end side of the suspension at the time of loading. At the time of loading, similarly to FIG. 8(b), the magnetic head slider 1 is brought closer to the magnetic disk 101. In FIG. 9(b), the magnetic head slider 1 is so skewed that the innermost side of the disk is disposed higher, so that the amount of the magnetic head slider 1 getting closer to the magnetic disk 101 is suppressed. As such, the magnetic head slider 1 is prevented to a further degree from abutting the magnetic disk 101.

In this embodiment, the slider corner section of the magnetic head slider on the air outflow side, especially the slider corner section on the innermost side of the disk, is trimmed so that the taper section is formed. This enables to prevent the magnetic head slider from abutting the magnetic disk at the time of loading. Accordingly, the load/unload region of the magnetic disk may be reduced in size, and the data recording region may be increased in size. Moreover, by forming the taper section with a space from the rail surface and the step-bearing surface, the magnetic head slider is prevented from abutting the magnetic disk without degrading the flying characteristics of the magnetic head slider. Instead of forming the taper section in the very proximal to the rail surface, the area of the taper section is set to a predetermined ratio with respect to the extension region on the side of the air outflow end, and the taper section may be disposed at the position of a predetermined ratio with respect to a line drawn on the downstream of the rail surface. This may reduce the influence over the flying characteristics to a further extent.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic disk drive, comprising:
a magnetic head slider including a magnetic transducer that accesses a recording region of a recording disk;
a ramp on to which the magnetic head slider is unloaded from the recording disk; and
an actuator that includes a suspension for supporting the magnetic head slider, and loads/unloads the magnetic head slider to/from the ramp,
wherein the magnetic head slider includes:
a rear pad having an outflow-side rail surface at a center portion on an air outflow end side of an air-bearing surface facing the recording disk;
a front pad that extends to an innermost side and an outermost side of the recording disk on the air bearing surface, and has a side rail surface on the air outflow end side; and
a first taper section that is formed to a first corner vertically of the air bearing surface on the air outflow end side by trimming a predetermined area of an extension region that is an extension portion having the maximum width of the side rail surface extended to the air outflow end.

2. The magnetic disk drive according to claim 1, wherein
the area of trimming the first corner is the area covering less than 70% of the extension region.

3. The magnetic disk drive according to claim 1, wherein
the area of trimming the first corner is the area covering almost 45% of the extension region.

4. The magnetic disk drive according to claim 1, wherein
the area of trimming the first corner is the area covering less than 30% of the extension region.

5. The magnetic disk drive according to claim 1, wherein
the first taper section is formed with a space from the side rail surface, and not covering a region on a side of the outflow-side rail surface closer than the side rail surface.

6. The magnetic disk drive according to claim 1, wherein
the first taper section is formed to a corner on a recording disk innermost side of the air-bearing surface on the air outflow end side of the magnetic head slider.

7. The magnetic disk drive according to claim 6, wherein
the first taper section is formed with a space from the side rail surface on the innermost side of the air-bearing surface.

8. The magnetic disk drive according to claim 6, wherein
the magnetic head slider is further provided with a second taper section at a second corner on an outermost side of the recording disk on the air outflow end side of the magnetic head slider.

9. The magnetic disk drive according to claim 8, wherein
the second taper section is formed with a space from the side rail surface on the outermost side.

10. The magnetic disk drive according to claim 1, wherein
a front pad is further provided with a side step bearing surface that is formed with a height difference from the side rail surface, and
the first taper section is formed with a space from the side step bearing surface.

11. The magnetic disk drive according to claim 1, wherein
the first taper section is formed not to cover the side rail surface when viewed from a side of the air-bearing surface.

12. The magnetic disk drive according to claim 1, wherein
the first taper section is formed outside of a line that is drawn to abut the side rail surface corresponding to a skew angle.

13. The magnetic disk drive according to claim 1, wherein
the magnetic head slider has a negative pressure generation surface that generates a negative pressure on the air bearing surface, and
the first taper section is formed from the negative pressure generation surface.

14. A magnetic disk drive, comprising:
a magnetic head slider including a magnetic transducer that accesses a recording region of a recording disk;
a ramp on to which the magnetic head slider is unloaded from the recording disk; and
an actuator that includes a suspension for supporting the magnetic head slider, and loads/unloads the magnetic head slider to/from the ramp,
wherein the magnetic head slider includes:
a front pad provided on an air inflow end side of an air-bearing surface facing the recording disk;
an innermost-side side step bearing surface that extends the front pad on an innermost side of the recording disk;
an innermost-side side rail surface that is provided on the innermost-side side step bearing surface, and is protruding to a side of the recording disk; and
a taper section formed by vertically removing the air bearing surface only on a side of the air outflow direction from a position at almost 50% of a line extending in an air outflow direction at the time of loading from an air outflow end of the innermost-side side rail surface.

15. The magnetic disk drive according to claim 14, further comprising:
an outermost-side side step bearing surface that extends the front pad on an outermost side of the recording disk;
an outermost-side side rail surface that is provided on the outermost-side side step bearing surface, and is protruding to the side of the recording disk; and
a second taper section formed by removing the air bearing surface from an air outflow end of the outermost-side side rail surface with a similar ratio as the taper section at the innermost-side side rail surface.

16. A magnetic disk drive, comprising:
a magnetic head slider including a magnetic transducer that accesses a recording region of a recording disk, an ABS surface provided to an air bearing surface facing the recording disk, and a chamfering section that chamfers a region from a corner on a side of an air outflow end vertical to the air bearing surface to a region not covering the ABS surface;
a ramp onto which the magnetic head slider is unloaded from the recording disk; and
an actuator that includes a suspension for supporting the magnetic head slider, and moves the magnetic head slider.

17. The magnetic disk drive according to claim 16, wherein the ABS surface includes one or more rail surfaces.

18. The magnetic disk drive according to claim 16, wherein the ABS surface includes one or more step-bearing surfaces.

19. The magnetic disk drive according to claim 16, wherein the ABS surface includes one or more rail surfaces and one or more step-bearing surfaces.
